(19) United States
(12) Patent Application Publication
(10) Pub. No.: US 2025/0173287 A1
(43) Pub. Date: May 29, 2025

(54) FILTER DEVICE AND METHOD FOR COMMUNICATION BETWEEN A TRUSTED DOMAIN AND AN UNTRUSTED DOMAIN, AND COMPUTER SYSTEM

(71) Applicant: Airbus Operations GmbH, HAMBURG (DE)

(72) Inventors: Daniel Alexander KLIEM, HAMBURG (DE); Jens HOLLANDER, HAMBURG (DE)

(21) Appl. No.: 18/961,979

(22) Filed: Nov. 27, 2024

(30) Foreign Application Priority Data
Nov. 29, 2023 (EP) 23212882.7

(51) Int. Cl. G06F 13/20

(52) U.S. Cl. CPC G06F 13/20; G06F 2213/40

(57) ABSTRACT

Filter device for communication between a trusted domain and an untrusted domain, comprising: a CPU and a device connected thereto and comprising a first interface connected to the untrusted domain and a second interface connected to the trusted domain, the interfaces receive and transmit data frames from and to the respective domain, a first filter channel filters a data frame received from the first interface and provides a first filtered data frame to the second interface, and a second filter channel filters a second data frame received from the second interface and provides a second filtered data frame to the first interface, a demultiplexer receives the respective data frames, classifies data streams according to at least one attribute, and inputs the data streams into a hardware and a software filter chains according to their classification to provide filtered data streams. The filtered data streams are combined.

### CROSS-REFERENCES TO RELATED APPLICATIONS

This application claims the benefit of European Patent Application Number 23212882.7 filed on Nov. 29, 2023, the entire disclosure of which is incorporated herein by way of reference.

### FIELD OF THE INVENTION

The invention relates to a filter device as well as to a method for communication between a trusted domain and an untrusted domain, and a computer system for an aircraft comprising the filter device.

### BACKGROUND OF THE INVENTION

In information technology, firewalls and gateway functions are often realized as software functions e.g. based on a Linux operating system kernel including a net filter stack or respective implementations of the BSD/OS Unix operating system. These measures have the benefit of widespread use. However, due to security requirements for an aircraft, such as High-Security Assurance Level requirements, which require detailed evidence for the correctness of all parts of the barrier, an embedded solution is preferred that is tailored to the needs of such application.

The problem of the present invention is thus to provide a device for secure communication with improved flexibility and simplicity.

### SUMMARY OF THE INVENTION

According to the invention, this problem may be solved by one or more embodiments described herein.

According to a first aspect of the invention, a filter device for communication between a trusted domain and an untrusted domain is provided. The filter device comprises a central processing unit, CPU, and a hardware programmable device connected to the CPU, the hardware programmable device comprising: a first input/output, I/O, interface connected to the untrusted domain and a second I/O interface connected to the trusted domain, wherein the first and second I/O interfaces are configured to receive and transmit data frames from and to the respective untrusted and trusted domain, a first filter channel configured to filter a first data frame received from the first I/O interface and provide a first filtered data frame to the second I/O interface, and a second filter channel configured to filter a second data frame received from the second I/O interface and provide a second filtered data frame to the first I/O interface; wherein each of the first and second filter channels comprises: at least two filter chains selected from a hardware filter chain and/or a software filter chain, wherein the hardware filter chain and the software filter chain comprise hardware filter circuitry and the software filter chain comprises software circuitry connected to the CPU, a demultiplexer configured to receive the respective first and second data frames from the respective first and second I/O interfaces, classify data streams of the respective first and second data frames according to at least one attribute, and input the data streams into the hardware filter chain and the software filter chain according to their classification to provide filtered data streams, a multiplexer configured to combine the filtered data streams from the hardware filter chain and the software filter chain to provide respective first and second filtered data frames and transmit the first and second filtered data frames to the respective second and first I/O interfaces.

According to a second aspect of the invention, a method for communication between an untrusted domain and a trusted domain for communication between an untrusted domain and a trusted domain is provided. The method comprises receiving data frames from one of the trusted domain and the untrusted domain by an input/output I/O interface, classifying the received data frames according to at least one attribute by a demultiplexer to provide classified data streams, inputting the classified data streams into at least two filter chains selected from a hardware filter chain and/or a software filter chain according to their classification, wherein the hardware filter chain and the software filter chain comprise hardware filter circuitry on a hardware programmable device, and wherein the software filter chain comprises software circuitry connected to a central processing unit, CPU, filtering the classified data streams by the hardware and software filter circuitry to provide filtered data streams, combining the filtered data streams from the hardware filter chain and the software filter chain by a multiplexer to provide filtered data frames, transmitting filtered data frames to the other of the trusted domain and the untrusted domain.

According to a third aspect of the invention, a computer system is provided. The computer system comprises a trusted domain, an untrusted domain, and an inventive filter device connected to the trusted domain and untrusted domain of the computer system.

A fundamental concept of the invention is to realize a barrier in a modular approach, to identify needed modules and to select for each module whether it is best implemented by means of (programmable) hardware or software means, such as hardware or software filters.

This present invention employs a combination of a general purpose Central Processing Unit (CPU) to run the software filters and programmable hardware (Custom) Device (such as a Field-Programmable Gate Array FPGA). Both parts, the CPU, i.e., the software, and the hardware programmable device, such as the FPGA are connected by adequately fast data interfaces.

By the modular approach and application of hardware/software co-design the solution is observable by each modular component or block, scalable by modular blocks and an addition of further blocks is possible. The filter device provides high-performance, low-latency hardware-based implementations.

A particular advantage in the solution according to an aspect of the invention is the realization of some of the modules by means of FPGA/programmable hardware. In a long-running, large project not all future needs are known a-priori. FPGA/Programmable hardware in combination with software provides the benefit of field loadability, i.e., replacing programmable hardware blocks in the field. This combines flexibility with performance and scalability.

The filter device of the present invention is thus a realization of an Ethernet frame checker, filter and translator that performs correctness checks of incoming and outgoing data that contain data frames.

The filter device classifies the data frames into so-called “streams” based on properties such as frame attributes. The filter device then performs filtering, such as e.g., rate-limiting and starvation protection per stream and in-depth analysis of a stream's frame content. The filter device of the present invention may further be configured to rewrite stream contents in a non-uniform translation (“protocol-breach”), performing stateful checking and filtering by considering incoming and outgoing traffic, performing checking and filtering based on conditions that are controlled from the secure side. The filter device is observable by means of statistics and event counters per stream.

The computer system preferably is a or a part of an aircraft management system onboard an aircraft. In this case, critical parts of the aircraft management system e.g., related to the navigation of the aircraft, may be located in the trusted domain and require to be protected from attacks by the filter device.

Advantageous embodiments and further developments emerge from the description with reference to the figures.

According to some aspects of the filter device according to the invention, each of the hardware circuitry comprises a stream filter and a rate limiter configured to limit a data rate of the data stream. The stream filter implements a protocol-specific state machine that can inspect individual frames based on data that is gathered when iterating over a single frame. A go/no-go decision is formed by these state machines finally. In case of a “go” decision, depending on the connection, some frames are directly forwarded, while for other streams the frames are put into a buffer memory, such as a FIFO buffer, for further inspections by the software translators and inspectors. The rate limiter ensures that for a particular stream excessive load attacks, e.g., denial of service, can be blocked and that the secure side cannot be overloaded.

According to some further aspects of the filter device according to the invention, the hardware filter circuitry of the software filter chains and the hardware filter chains of the first and second filter channels are identical. In this way, the filter circuitries can be implemented as modules so that these are interchangeable between the first and second filter channels. It further allows additional filter channels when these are needed due to new requirements, e.g., in an aircraft.

According to some further aspects of the filter device according to the invention, the software circuitry is arranged downstream of the hardware circuitry in the software filter chains. In this way, the data signal may be filtered first by the hardware filter circuitry thereby removing potential threats for the software and CPU before being filtered by the CPU. In this way, the security the filter device is able to provide is improved.

According to some further aspects of the filter device according to the invention, the first filter channel and/or the second filter channel comprises a plurality of hardware filter chains and/or a plurality of software filter chains coupled between the respective demultiplexer and multiplexer, wherein the respective demultiplexers and multiplexers are configured to classify the received data frames according to at least one attribute, input the classified data streams of the data frames to one of the respective plurality of hardware filter chains and/or the plurality of software filter chains according to their classification and combine the filtered data streams to provide the first and second filtered frames. The first and second filter channels may comprise different numbers of hardware filter chains and software filter chains. For example, the first and second filter chains may comprise two software filter chains and no hardware filter chain, or three software filter chains and five hardware filter chains. Further combinations are thinkable. In this way, the flexibility of the filter device is increased as it can provide more filter channels for filtering particular potential threats.

According to some further aspects of the filter device according to the invention, the I/O interfaces are configured as a Media Access Control, MAC, interface. The MAC interface is a physical layer of the Ethernet to send and receive frames. The MAC interface includes checkers for basic parameters of ingress frames such as size, and correctness of the frame checksum. This is done prior to stream classification in order to avoid decision-making that is based on corrupted frame data.

According to some further aspects of the filter device according to the invention, the CPU comprises a translator and inspector software block connected to the software circuitry and configured to inspect a state of the data received from the software circuitry and receive pre-filtered data from the software filter chain and translate between different protocols of the received data. The inspector can derive stateful behavior within and between data streams and even between incoming and outgoing directions. It thus improves the capability of filtering potentially insecure data by this software circuitry. This translator is an additional security benefit to terminate incoming protocols on the non-trusted side of the barrier and continue the flow with another protocol.

According to some further aspects of the filter device according to the invention, the CPU comprises a control and monitoring software block configured to communicate only with the second I/O interface of the programmable hardware connected to the trusted domain. With this control and monitoring software block, it is possible to securely reprogram the programmable hardware. Therefore, monitoring and configuration cannot be exposed to the insecure side, i.e., the untrusted domain, in order to prevent attacks on the barrier itself.

According to some further aspects of the filter device according to the invention, the software circuitry is configured as a buffer memory, in particular a FIFO buffer, to perform an exchange of data with the software unit. In this way, the data signals can be stored and retrieved by the CPU when needed.

The above embodiments and further developments can be combined with each other as desired, if useful. In particular, all features of the filter device are transferable to the method for assembling the display device, and vice versa. Further possible embodiments, further developments and implementations of the invention also comprise combinations, not explicitly mentioned, of features of the invention described before or below with respect to the embodiments. In particular, the skilled person will thereby also add individual aspects as improvements or additions to the respective basic form of the present invention.

### BRIEF DESCRIPTION OF THE DRAWINGS

The present invention is explained more specifically below on the basis of the exemplary embodiments indicated in the schematic figures, in which:

FIG. 1 shows a schematic illustration of a filter device for communication between a trusted domain and an untrusted domain according to an embodiment of the invention;

FIG. 2 shows a schematic illustration of a filter device for communication between a trusted domain and an untrusted domain according to a further embodiment of the invention;

FIG. 3 shows a schematic illustration of an computer system for an aircraft according to an embodiment of the invention; and

FIG. 4 shows a flow chart for a method for communication between a trusted domain and an untrusted domain according to a further embodiment of the invention.

In the figures of the drawing, elements, features and components that are the same, have the same function and have the same effect are each provided with the same reference signs—unless explained otherwise.

### DETAILED DESCRIPTION OF THE PREFERRED EMBODIMENTS

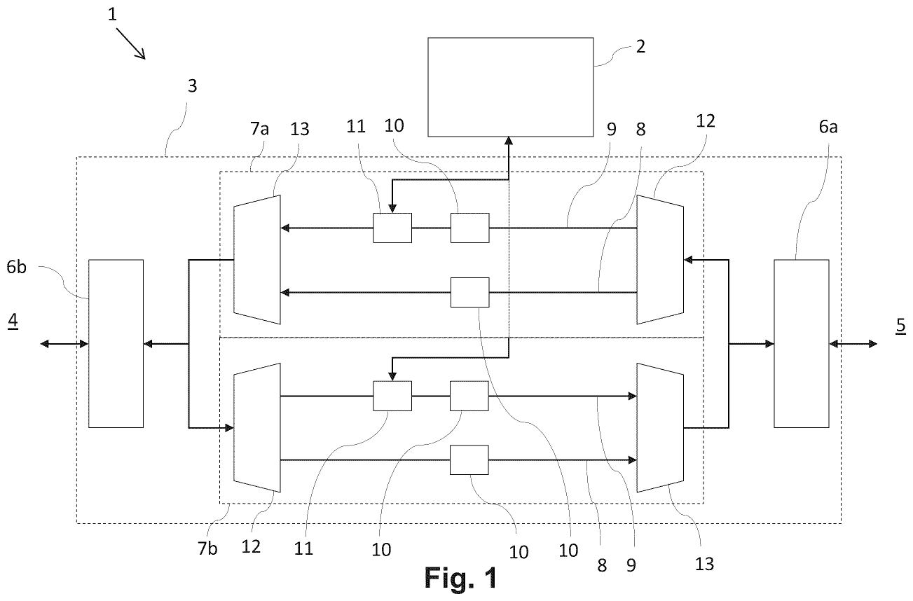

FIG. 1 shows a schematic illustration of a filter device 1 for communication between a trusted domain 4 and an untrusted domain 5 according to an embodiment of the invention.

The filter device 1 comprises a central processing unit, CPU 2. The CPU thus represents a general purpose software block that can be programmed by software freely. Typical commercially available CPU can be employed for this task.

The filter device further comprises a hardware programmable device 3 connected to the CPU 3. In some embodiments, the hardware programmable device is configured as a Field-programmable Gate Array, FPGA. The filter device 1 thus includes a combination of a general-purpose CPU to run the software filters and a programmable hardware custom Device. Both parts, CPU 2, i.e., the software, and the programmable hardware device 3, e.g., the FPGA, are connected by adequately fast data interfaces.

The hardware programmable device 3 comprises a first input/output, I/O, interface 6a connected to the untrusted domain 5. The hardware programmable device 3 further comprises a second I/O interface 6b that is connected to the trusted domain 4. The first I/O interface 6a is configured to receive and transmit data frames from and to the untrusted domain 5. The second I/O interface 6b is configured to receive and transmit data frames from and to the trusted domain 4.

In preferred embodiments, the first and second I/O interfaces 6a, 6b are configured as a Media Access Control, MAC, interface. The MAC interface is a physical layer of the Ethernet to send and receive frames. As described above, the MAC interface includes checkers for basic parameters of ingress frames such as size, and correctness of the frame checksum. A data frame typically includes frame synchronization features consisting of a sequence of bits or symbols that indicate to the receiver the beginning and end of the payload data within the stream of symbols or bits it receives.

The hardware programmable device 3 further comprises a first filter channel 7a that is configured to filter a first data frame received from the first I/O interface 6a and provide a first filtered data frame to the second I/O interface 6b. The hardware programmable device 3 further comprises a second filter channel 7b configured to filter a second data frame received from the second I/O interface 6b and provide a second filtered data frame to the first I/O interface 6a.

Each of the first and second filter channels 7a, 7b comprises a hardware filter chain 8 and a software filter chain 9. The hardware filter chain 8 and the software filter chain 9 comprise hardware filter circuitry 10 and the software filter chain 9 comprises software circuitry 11 connected to the CPU 2. In the embodiment shown in FIG. 1, the software circuitry 11 is arranged downstream of the hardware circuitry 10 in the software filter chains 9. In this way, the data signal may be filtered first by the hardware filter circuitry thereby removing potential threats for the software and CPU before being filtered by the CPU. In this way, the security is improved.

Each of the first and second filter channels 7a, 7b further comprises a demultiplexer 12 that is configured to receive the respective first and second data frames from the respective first and second I/O interfaces 6a, 6b, classify data streams of the respective first and second data frames according to at least one attribute, and input the data streams into the hardware filter chain 8 and the software filter chain 9 according to their classification to provide filtered data streams. The demultiplexer 12 thus inspects frame fields as attributes, such as source and destination addresses, a frame type, a VLAN tags, IP addresses, UDP ports, and distributes matching frames to respective per-stream filter chains. The stream splitter can perform masked comparisons of frame fields. The demultiplexer 12 can also drop non-matching frames.

In the embodiment shown in FIG. 1, the hardware filter circuitry 10 of the software filter chains 9 of the first and second filter channels 7a, 7b and the hardware filter circuitry 10 of the hardware filter chains 8 of the first and second filter channels 7a, 7b are identical. In this way, the hardware and also software filter circuitries 10, 11 can be implemented as modules so that these are interchangeable between the first and second filter channels. It further allows additional filter channels when these are needed due to new requirements, e.g., in an aircraft.

Each of the first and second filter channels 7a, 7b further comprises a multiplexer 13 that is configured to combine the filtered data streams from the hardware filter chain 8 and the software filter chain 9 to provide respective first and second filtered data frames and transmit the first and second filtered data frames to the respective second and first I/O interfaces 6a, 6b. The multiplexer 13 is the counterpart of the demultiplexer 12. It is necessary to decide the order in which accepted filtered frames can egress the barrier. This multiplexer 13 can also enforce a priority among the filter channels 7a, 7b or stream filter chains that are running in parallel. This effectively enforces prioritization of streams in the traffic and in combination with the rate-limiting blocks also prevents starvation of the streams.

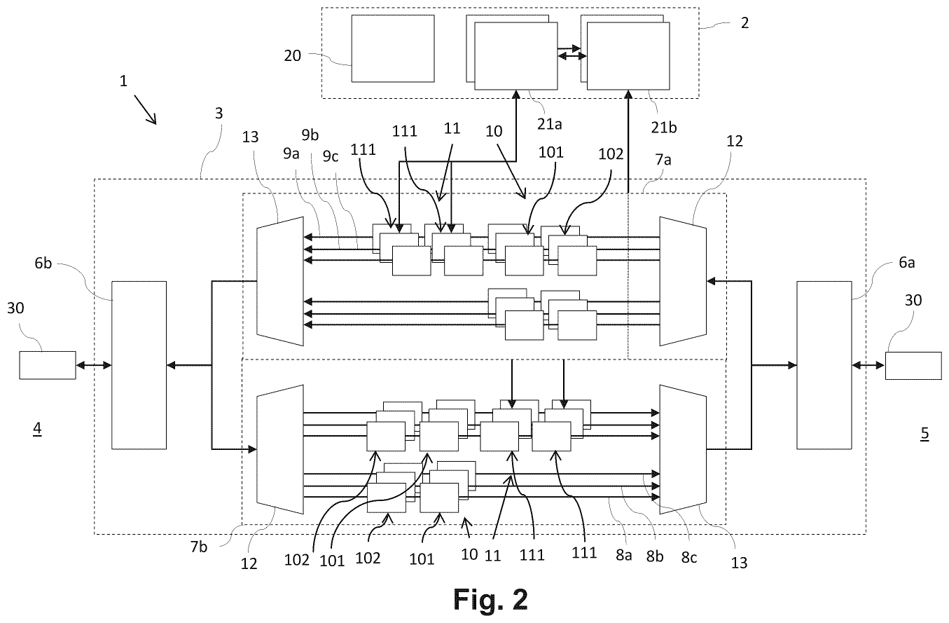

FIG. 2 shows a schematic illustration of a filter device 1 for communication between a trusted domain 4 and an untrusted domain 5 according to a further embodiment of the invention.

The embodiment of the filter device 1 shown in FIG. 2 is based on the filter device 1 described above and shown in FIG. 1.

The first filter channel 7a and the second filter channel 7b comprises at least two selected of a plurality of hardware filter chains 8a-8c and/or a plurality of software filter chains 9a-9c coupled between the respective demultiplexer 12 and multiplexer 13. In this embodiment, each of the first filter channel 7a and the second filter channel 7b each comprises six filter chains, i.e., three hardware filter chains 8 and three software filter chains 9. In further embodiments, the first and second filter channels 7a, 7b comprise different numbers of hardware filter chains 8 and software filter chains 9. In some embodiments, the first and second filter channels 7a, 7b comprise two software filter chains 9 and no hardware filter chain 8, or the first and second filter channels 7a, 7b comprise three software filter chains 9 and five hardware filter chains 8. Other combinations of the n of software chains 9 and hardware chains 8 are thinkable as well.

The respective demultiplexers 12 and multiplexers 13 are configured to classify the received data frames according to at least one attribute, input the classified data streams of the data frames to one of the respective plurality of hardware filter chains 8a-8c and/or the plurality of software filter chains 9a-9c according to their classification and combine the filtered data streams to provide the first and second filtered frames.

The software circuitry 11 is configured as a buffer memory 111 frames, in particular a FIFO buffer, to perform an exchange of data with the CPU 2. The buffer memory 111 is capable of storing the data streams so that these can be retrieved by the CPU when needed.

In the embodiment of FIG. 2, each of the hardware circuitry 10 comprises a stream filter 101. The hardware circuitry 10 also comprises a rate limiter 102 that is positioned upstream the stream filter 101. The stream filter 101 typically implements a protocol-specific state machine that can inspect individual frames based on data that is gathered when iterating over a single frame. A go/no-go decision is formed by these state machines finally. In case of a “go” decision, depending on the connection, some frames are directly forwarded, while for other streams the frames are put into the buffer memory 111, such as the FIFO buffer, for further inspections by the software translators and inspectors. The rate limiter 102 is configured to limit a data rate of the data stream. The rate limiter 102 ensures that for a particular stream excessive load attacks, e.g., denial of service, can be blocked and that the secure side cannot be overloaded.

In the embodiment of the filter device 1 shown in FIG. 2, the CPU 2 comprises a translator and inspector software block 21a, 21b connected to the software circuitry 11 and configured to inspect a state of the data received from the software circuitry and receive pre-filtered data from the software filter chain and translate between different protocols of the received data.

The CPU 2 further comprises a control and monitoring software block 20 configured to communicate only with the second I/O interface 6b of the programmable hardware 3 connected to the trusted domain 4. The control and monitoring software block 20 is further capable of reprogramming the circuitries in the hardware programmable device. For this, the control and monitoring software block 20 only communicates with the secure side of the I/O interface 6b. In this way, monitoring and configuration cannot be exposed to insecure side, i.e., the untrusted domain 5, in order to prevent attacks to the barrier itself.

Further shown in FIG. 2 is a physical ethernet attachment 30 of the aircraft management system 100 each connected to the first and second I/O interfaces. The incoming data frames as well as the filtered data frames are thus sent by ethernet through the physical ethernet attachment 30.

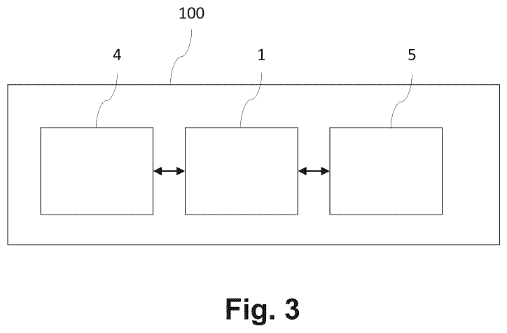

FIG. 3 shows a schematic illustration of a computer system for an aircraft according to an embodiment of the invention.

The computer system 100 shown in FIG. 3 comprises a trusted domain 4, an untrusted domain 5, and a filter device 1 according to an embodiment of the invention. The filter device 1 is connected to the trusted domain 4 and untrusted domain 5 for data exchange. In preferred embodiments, the computer system 100 is integrated in an aircraft. In a preferred embodiment, the computer system 100 is at least a part of an aircraft management system onboard and integrated into an aircraft.

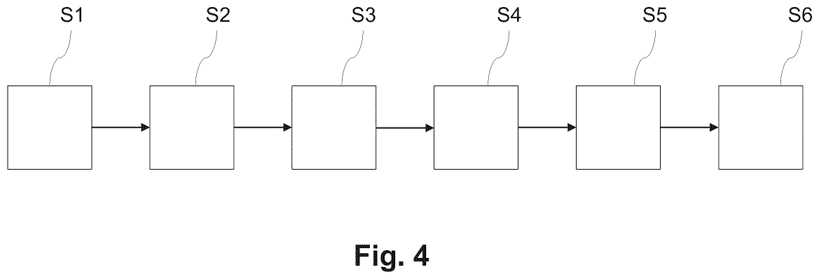

FIG. 4 shows a flow chart for a method for communication between a trusted domain and an untrusted domain according to a further embodiment of the invention.

The method for communication between a trusted domain 4 and an untrusted domain 5 comprises the step of receiving S1 data frames from one of the trusted domain 4 and the untrusted domain 5 by an input/output I/O interface 6a, 6b. Then, the received data frames are classified S2 according to at least one attribute by a demultiplexer 12 to provide classified data streams. The classified data streams are input S3 into a hardware filter chain 8 and a software filter chain 9 according to their classification. The hardware filter chain 8 and the software filter chain 9 comprise hardware filter circuitry 10 on a hardware programmable device 3. The software filter chain 9 further comprises software circuitry 11 connected to a central processing unit, CPU 2. Furthermore, the classified data streams are filtered S4 by the hardware and software filter circuitry 10, 11 to provide filtered data streams. The filtered data streams from the hardware filter chain 8 and the software filter chain 9 are combined S5 by a multiplexer 13 to provide filtered data frames. In an additional step, the filtered data frames are transmitted S6 to the other of the trusted domain 4 and the untrusted domain 5.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

In the detailed description above, various features have been combined in one or more examples in order to improve the rigorousness of the illustration. However, it should be clear in this case that the above description is of merely illustrative but in no way restrictive nature. It serves to cover all alternatives, modifications and equivalents of the various features and exemplary embodiments. Many other examples will be immediately and directly clear to a person skilled in the art on the basis of his knowledge in the art in consideration of the above description.

The exemplary embodiments have been chosen and described in order to be able to present the principles underlying the invention and their application possibilities in practice in the best possible way. As a result, those skilled in the art can optimally modify and utilize the invention and its various exemplary embodiments with regard to the intended purpose of use. In the claims and the description, the terms “including” and “having” are used as neutral linguistic concepts for the corresponding terms “comprising”. Furthermore, the use of the terms “a”, “an” and “one” shall not in principle exclude the plurality of features and components described in this way.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps, which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 filter device
2 Central Processing Unit, CPU
3 hardware programmable device
4 trusted domain
5 untrusted domain
6a, 6b input/output, I/O, interface
7a, 7b filter channels
8, 8a-c hardware filter chains
9, 9a-c software filter chains
10 hardware filter circuitry
11 software filter circuitry
20 control and monitoring software block
21a, 21b translator and inspector software block
30 Physical Ethernet Attachment
100 computer system
101 stream filter
102 rate filter
111 buffer memory

1. A filter device for communication between a trusted domain and an untrusted domain, comprising:
a central processing unit, CPU, and
a hardware programmable device connected to the CPU, the hardware programmable device comprising:
a first input/output, I/O, interface connected to the untrusted domain and a second I/O interface connected to the trusted domain, wherein the first I/O interface and the second I/O interface are each configured to receive and transmit data frames from and to the respective untrusted and trusted domains,
a first filter channel configured to filter a first data frame received from the first I/O interface and provide a first filtered data frame to the second I/O interface, and
a second filter channel configured to filter a second data frame received from the second I/O interface and provide a second filtered data frame to the first I/O interface;
wherein each of the first and second filter channels comprises:
at least two filter chains selected from a hardware filter chain, a software filter chain, and a combination thereof, wherein the hardware filter chain and the software filter chain comprise hardware filter circuitry and the software filter chain comprises software circuitry connected to the CPU,
a demultiplexer configured to receive the respective first and second data frames from the respective first and second I/O interfaces, classify data streams of the respective first and second data frames according to at least one attribute into a classification, and input the data streams into the hardware filter chain and the software filter chain according to the classification to provide filtered data streams,
a multiplexer configured to combine the filtered data streams from the hardware filter chain and the software filter chain to provide respective first and second filtered data frames and transmit the first and second filtered data frames to the respective second and first I/O interfaces.

2. The filter device according to claim 1, wherein each of the hardware circuitry comprises a stream filter and a rate limiter configured to limit a data rate of the respective data stream.

3. The filter device according to claim 1, wherein the hardware filter circuitry of the software filter chains and the hardware filter chains of the first and second filter channels are identical.

4. The filter device according to claim 1, wherein the software circuitry is arranged downstream of the hardware circuitry in the software filter chains.

5. The filter device according to claim 1, wherein the first filter channel, or the second filter channel, or both comprise a plurality of hardware filter chains, or a plurality of software filter chains coupled between the respective demultiplexer and multiplexer, or both,
wherein the respective demultiplexers and multiplexers are configured to classify the received data frames according to at least one attribute into classifications, input the data streams of the data frames to one of the respective plurality of hardware filter chains, or the plurality of software filter chains according to the classifications, or both, and combine the filtered data streams to provide the first and second filtered frames.

6. The filter device according to claim 1, wherein the first and the second I/O interfaces are each configured as a Media Access Control, MAC, interface.

7. The filter device according to claim 1, wherein the CPU comprises a translator and inspector software block connected to the software circuitry and configured to inspect a state of data received from the software circuitry and receive pre-filtered data from the software filter chain and translate between different protocols of the data received.

8. The filter device according to claim 1, wherein the CPU comprises a control and monitoring software block configured to communicate only with the second I/O interface of the programmable hardware device connected to the trusted domain.

9. The filter device according to claim 1, wherein the software circuitry is configured as a buffer memory frames to perform an exchange of data with the CPU.

10. A computer system for an aircraft, comprising:
a trusted domain,
an untrusted domain, and
a filter device according to claim 1 connected to the trusted domain and untrusted domain of the aircraft.

11. A method for communication between a trusted domain and an untrusted domain, comprising:
receiving data frames from one of the trusted domain and the untrusted domain by an input/output I/O interface,
classifying the received data frames according to at least one attribute by a demultiplexer to provide classified data streams,
inputting the classified data streams into at least two filter chains, selected from a hardware filter chain, a software filter chain, a combination thereof, according to a classification, wherein the hardware filter chain and the software filter chain comprise hardware filter circuitry on a hardware programmable device, and wherein the software filter chain comprises software circuitry connected to a central processing unit, CPU,
filtering the classified data streams by the hardware filter circuitry and the software filter circuitry to provide filtered data streams,
combining the filtered data streams from the hardware filter chain and the software filter chain by a multiplexer to provide filtered data frames, and,
transmitting filtered data frames to the other of the trusted domain and the untrusted domain.
